(19) United States
(12) Patent Application Publication
(10) Pub. No.: US 2023/0082462 A1
(43) Pub. Date: Mar. 16, 2023

(54) CONNECTING STRUCTURE OF SEGMENTED WIND TURBINE BLADES

(71) Applicant: DUPONT POLYMERS, INC., WILMINGTON, DE (US)

(72) Inventor: EDWIN CARLO GOYZUETA, STOW, OH (US)

(21) Appl. No.: 17/930,744

(22) Filed: Sep. 9, 2022

Related U.S. Application Data
(60) Provisional application No. 63/244,464, filed on Sep. 15, 2021.

(51) Int. Cl. F03D 1/06

(52) U.S. Cl. CPC F03D 1/0675; F05B 2240/302; F05B 2260/30; F05B 2280/4005; F05B 2280/6003; F05B 2280/6011; F05B 2280/501

(57) ABSTRACT

A connecting structure of segmented wind turbine blade containing a metallic pin with a coating layer of self-lubricating liner containing a polymer matrix, aramid filers and polytetrafluoroethylene fibers, and multiple metallic bushings is disclosed.

### CROSS-REFERENCE TO RELATED APPLICATION

This application claims priority under 35 U.S.C. § 365 to U.S. Provisional application No. 63/244,464, filed on Sep. 15, 2021 which is incorporated herein by reference in its entirety.

### TECHNICAL FIELD

This invention relates to a connecting structure of segmented wind turbine blades containing a pin and bushings.

### BACKGROUND

The wind turbine industry is introducing modular or segmented blade designs to improve performance and aid in logistic simplification. Segmented blade designs can be made up of several segments with most common being two pieces blade designs. Joints design at each segment can also vary from bolted, threaded joints, pin joints, and dovetail mating type joints. A common joint design entails a metallic pin stabilized by several metallic bushings on each end of the pin.

US Patent Application Publication No. 2020/0224636 discloses a joint bushing that accommodates the dithering (±2°) and sliding in multi segment wind turbine blade. The joint bushing includes a self-lubricating liner bonded to the inside diameter of the bushing, that is a composite matrix made of woven/non-woven PTFE fibers intermixed with structural reinforcement fibers.

The challenge is reducing or eliminating maintenance of the joints since the wind turbine blades are set at very high altitudes. Typical needs for maintenance at these joints are due to wear induced by system vibrations/dithering. The two pieced blade designs will typically encompass a low friction/low wear material bonded to the inside diameter of the bushing which is intended to interface against the outside diameter of a connecting pin. This design option posses' challenges and potentially unnecessary manufacturing costs of trying to control tight tolerance and concentricity requirements between multiple bushing inside diameters and pin outside diameter. Extra measures are imposed to the manufacturing process of each bushing inside diameter to ensure they are as concentric or equal as possible. These measures can include tight tolerance parameters controlling the bushing inside diameter housing, adhesive bond line, liner bonding tooling parameters that can control the pressure during bonding, and potential final machining on the inside diameter bonded liner.

Other challenges include installation of a pin through several varying inside diameter of bushings. Such challenges can result in damaging/removal of the low wear coating applied to the inside diameter of the bushings during pin installation and or overhaul on the field, premature wear and failure due to unbalanced contact surfaces and stress concentrations.

### BRIEF SUMMARY

To reduce these challenges, a new liner system is developed and applied to the two pieced blade designs containing a pin and bushings.

A self-lubricating wear liner is applied to the pin outside surfaces which would aid in reducing the potential of damaging the liner during installation and would also aid in liner uniformity and concentricity relative to the pin outside diameter and bushing inside diameter. Which could potentially help extend the life of the liner system since the pressure profile would be more balanced. Other benefits would include reduced cost of manufacturing and improved dampening/vibration isolation at the pin and bushing interface when the self-lubricating liner is in uniform contact with the bushing inner diameter.

Accordingly, one aspect of the invention is connecting structure of segmented wind turbine blade, comprising a metallic pin and multiple metallic bushings, wherein the metallic pin has coating layer with a self-lubricating liner comprising (i) a polymer matrix, aramid filers and polytetrafluoroethylene fibers.

Another aspect of the invention is a wind turbine blade comprising the connecting structure disclosed above.

### BRIEF DESCRIPTION OF THE DRAWINGS

FIG. 1 is a perspective view of a two pieced wind turbine blades jointed by a pin and bushings.

FIG. 2a is a perspective view of a cross section of a pin and bushings, in which the pin is coated with self-lubricating liner (invented technology).

FIG. 2b is a cross sectional view of FIG. 2a.

FIG. 3a is a perspective view of a cross section of a pin and bushings, in which the bushings are coated with self-lubricating liner (existing technology).

FIG. 3b is a cross sectional view of FIG. 3a.

### DETAILED DESCRIPTION

In the specification, the word ‘self-lubricating’ means no lubricant is required such as metal to metal bushings which would require periodic greasing/lubrication at the joints.

The present invention relates to connecting structure of segmented wind turbine blade, comprising a metallic pin and multiple metallic bushings, wherein the metallic pin has coating layer with a self-lubricating liner comprising (i) a polymer matrix, aramide fillers and polytetrafluoroethylene fibers.

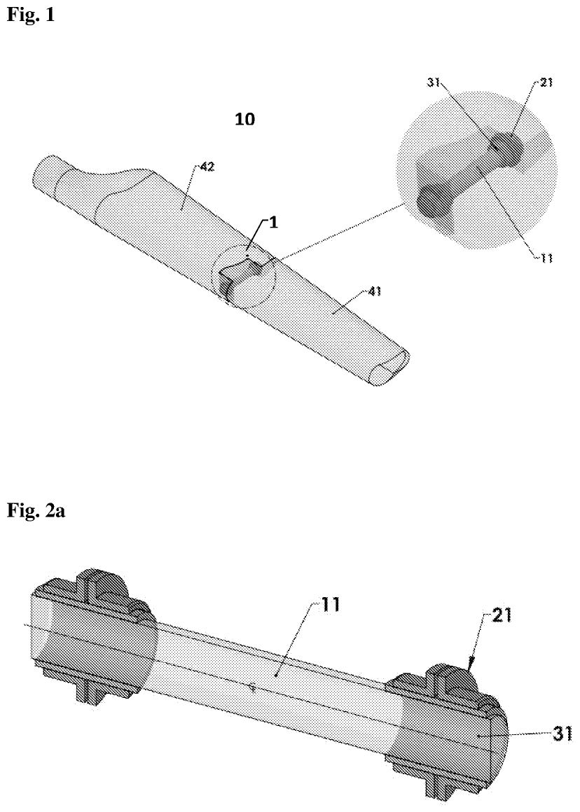

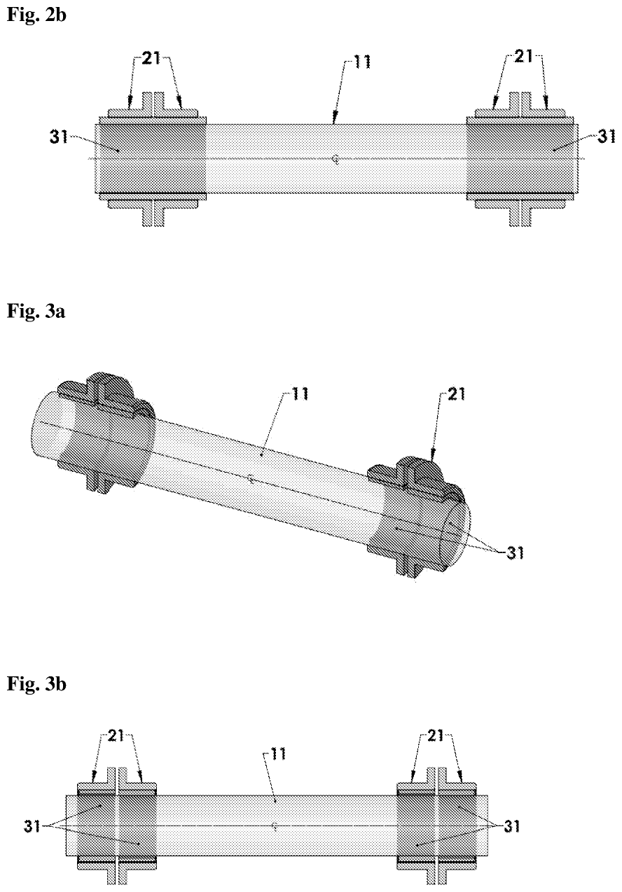

As shown in FIG. 1, a wind turbine blade (100) includes two pieces of blades (41, 42) and a connecting structure (1). The connecting structure (1) includes pin (11) and bushings (21) as disclosed in FIG. 2a. The each ends of the pin (11) is surrounded by multiple bushings (21). The connecting structure (1) connects two (2) sections of a blades (41, 42) with a semi-rigid joint that allows for slight movement/dithering as well as simplifying the joint. The design helps easy assembly and disassembly when overhaul is required.

As shown in FIG. 2a and FIG. 2b, the outer surface of the pin (11) has self-lubricating coating (31). The self-lubricating coating (31) is strongly fixed to the outer surface of the pin (11). The outer surface of the self-lubricating coating (31) faces to bushing (21).

Pin can be any material with adequate rigidity and strength to work in the design including but not limited to Aluminum, Carbon Steels, Stainless Steels, plastics, and composites.

Bushing material can be any material with adequate rigidity and strength to work in the design including but not limited to Aluminum, Carbon Steels, Stainless Steels, plastics, and composites.

Example of the self-lubricating coating is Vespel® CP-0630 hybrid self-lubricating coating, incorporating high strength structural fibers with PTFE fibers held together with a proprietary resin system. Vespel® CP-0630 is a self-lubricating coating capable of operating in compressive loads exceeding 35 ksi while offering minimal wear and low coefficient of friction. CP-0630 coating also offers a corrosion barrier between two (2) dissimilar materials such as protection against galvanic corrosion.

The thickness of the self-lubricating coating is from 0.1 to 0.5 mm, preferably from 0.2 to 0.4 mm, more preferably from 0.25 to 0.35 mm.

FIGS. 3a and 3b shows existing connecting structure. A pin (11) is stabilized by four bushings (21) on each end of the pin. Each bushing (11) has self-lubricating liner (31) on its inner surface. The four bushings need to be concentric or equal with one another as they interface against the pin. Since each of the bushings have self-lubricating coatings (31) on the inner diameter of the bushing (11), this design option posses' challenges and potentially unnecessary manufacturing costs of trying to control tight tolerance and concentricity requirements between multiple bushing inside diameters and pin outside diameter.

The invented connecting structure have the following advantages over existing technology.

Ease of Assembly: Incorporating the self-lubricating liner onto the outside diameter of the pin instead of the common incorporation into the inside diameter of multiple bushings allows for simplification of manufacturing, Ease of assembly, Ease of repair and replacement, and improved performance. It is the simplification of being able to insert a coated pin into a pre-assembled structure instead of installing each bushing independently.

Ease of Manufacturing: coating on an exterior surface (outside diameter of pin) is easier as compared to coating an interior surface (inside diameter of bushing). In addition, it is also the reduction of labor and simplification going from coating 4, 6, 8, or more bushing interior surfaces to coating only 2 or less exterior surfaces of a pin (coated each end of the pin and depending on the joint design ad pin length, once could coat the entire surface of the pin so 1 single liner system throughout the entire outside surface of the pin).

Ease of repair and replacement: It comes from the ability to remove a joint pin in application without the need to remove the metal bushings/components and or complete or semi-complete assembly. One could theoretically conduct this repair/overhaul process in the field.

Improved Performance: It comes from simplification of the manufacturing process of bonding a self-lubricating system to an exterior surface compared to an interior surface. Bonding to an exterior surface allows for improved bond line thickness control thus improving contact surface and making it more uniform and even distribution of load and wear performance. It also comes from reducing component count, the difficulty of controlling liner thickness and concentricity with inside diameter lined bushings in series compared to controlling thickness and concentricity on a lined pin (2 ends coated). Improved thickness control in this application can aid in overall system wear performance by ensuring a uniform contact pressure and wear surface from start to end of life.

### EXAMPLES

Test samples were prepared in the following manner. Rectangular Aluminum strips were coated on 1 side with Vespel CP-0630 and positioned on a 3 point bend fixture on a DMA (dynamic mechanical analyzer) where the bare aluminum was contacting 2 points (1 on each end) and the center plunger making contact to the Vespel CP-0630 coated side. The plunger then made contact and a dynamic amplitude was imposed on the sample per parameters on Table 1. This testing was repeated on a bare aluminum sample and compared with the test samples coated by Vespel CP-0630 (Table 2). The damping properties was improved about 50% compared to the testing of bare metal.

TABLE 1

| | Static | Dyn. Disp | Freq. Range |
|---|---|---|---|
| Mode | Disp(mm) | (mm) | (Hz) |
| 3-point | 0.01 | 0.005 | 1 to 1,000 |
| bending | | | |

TABLE 2

| Vespel CP-0630 coated Al | Bare Al |
|---|---|
| (Tangent Delta) | (Tangent Delta) |
| 0.15 | 0.09 |

What we claimed is:

1. A connecting structure of segmented wind turbine blade, comprising a metallic pin and multiple metallic bushings, wherein the metallic pin has coating layer with a self-lubricating liner comprising a polymer matrix, aramid filers and polytetrafluoroethylene fibers.

2. The connecting structure of claim 1, wherein the self-lubricating liner is a singly ply woven composite.

3. The connecting structure of claim 1, wherein the thickness of the coating is from 0.1 to 0.5 millimeters.

4. A wind turbine blade comprising the connecting structure of claim 1.
